(19) United States
(12) Patent Application Publication
(10) Pub. No.: US 2024/0076047 A9
(43) Pub. Date: Mar. 7, 2024

(54) Automatic Ejection Safety Technology with a Skydiving Simulator for Improving Pilot Safety

(71) Applicant: Mark Haley, McKinney, TX (US)

(72) Inventor: Mark Haley, McKinney, TX (US)

(21) Appl. No.: 16/852,505

(22) Filed: Apr. 19, 2020

Related U.S. Application Data
(63) Continuation-in-part of application No. 15/996,433, filed on Jun. 2, 2018, now Pat. No. 10,782,524.
(60) Provisional application No. 62/864,529, filed on Jun. 21, 2019.

(51) Int. Cl. B64D 25/08; B64C 13/18; G06F 3/01; G09B 9/00

(52) U.S. Cl. CPC B64D 25/08; B64C 13/18; G06F 3/012; G09B 9/00; G01S 19/42

(57) ABSTRACT

This invention provides an integrated pilot autonomous ejection system with skydiving safety/training which combines sensors, hardware and software technologies to improve pilot training and safety. It offers pilots state-of-the-art cost-effective Virtual Reality Skydiving and flight simulations which prepares pilots on skydiving after ejections and for the dangers of Vertigo and G-LOC which can result in a crash in seconds. Related flight data including cameras which constantly monitors pilots can be used for debriefings/accident investigations which can be done in minutes. The goal is to improve pilot safety during the transition to fully autonomous fleets of fighter jets which have better warrior capabilities.

### TECHNICAL FIELD

This invention is related to improving pilot safety during emergency ejections from aircraft with related easy-to-use skydiving simulators since the pilots must skydive after an ejection. The goal is to improve pilot safety during the transition to fully autonomous fleets of fighter jets which have better warrior capabilities.

### BACKGROUND

This invention, the Automatic Ejection Safety Technology (AEST), improves jet fighter pilot safety related to emergency ejections from aircraft with related 3D Virtual Reality (VR) skydiving simulators and the integrated collection of GPS tracking data for 3D mapping for debriefings and accident investigations. The simulator also trains pilots to be aware of the dangers of Vertigo and Gravity Loss of Consciousness (G-LOC). Related actual flight data continuously improves the simulator. Ultimately jet fighters will be fully autonomous to improve maneuverability and offensive options unimpeded by the limitations of humans (FIG. 5). Cameras would constantly monitor pilots during flights and there would be a breathalyzer and other data before flights if time is available. The goal: constantly monitor the condition of pilots flying $100 million jets. This data could be used for debriefings and/or accident investigations.

FIG. 1 highlights the causes of crashes of America's key fighters: F-15s, F-16s, F/A-18Fs and F-35s. In 2016-2018, 32 of these jets crashed, and 18 pilots died (47% of the 38 pilots) but 15 of those might have been saved with the safety systems in this patent. Moreover, related analysis shows that as many as 1 of 500 of these jets crash each year and recently F-35s were crashing at the rate of almost 1 per 400 jets/year. These statistics offer a compelling case for implementing the safety technology of this patent. The biggest customer for the F-35 is the US military which could purchase over 2,400 F-35s. Based on these statistics there could be 54 crashes of U.S. military F-35 crashes during 10 years delivery of these aircraft with 26 related pilot deaths. However, if this automatic ejection system in this patent was implemented there could be as few as 4 deaths. The system even prevents suicidal pilots from killing themselves.

If the AEST is enabled and it detects an impending crash, it: (1) either automatically ejects the pilot if there is not enough time to safely stop a crash, or (2) if it can the plane autonomously flies back to base without the need to eject the pilot. If the pilot was ejected, then the pilot's chute deploys and the pilot safely lands. The existing systems don't autonomously eject the pilot. In June 2019, a 41-year-old Japanese pilot who had Vertigo and/or G-LOC crashed his F35 killing the pilot and destroying the $100 million F35. The ideal solution—both an autonomous autopilot to take control if possible, if not then the AEST automatically ejects.

With existing technology, the pilot manually initiates an ejection. After an ejection (manual or automatic) their seat is thrust above the aircraft and within a few seconds their parachute is deployed. Then the pilot (now a skydiver) steers the parachute towards a safe landing while the jet crashes potentially killing people on the ground. Existing ejection seat patents focus on manual operations such as the Martin-Baker products which claims to have saved 7,402 pilots from 93 air forces. There are no related patents related to autonomously landing of the disabled aircraft. For example, Martin-Baker was involved in U.S. Pat. No. 9,241,545, Jan. 26, 2016 and U.S. Pat. No. 6,591,602 Jul. 15, 2003 and many others which focus on manual ejection seats without autonomous flight of the aircraft. While this patent recommends an improved autonomous seat ejection, if the system isn't effectively designed and/or tested it could be more dangerous than manual systems, so this is a disclaimer against implementing any poorly designed and/or tested automatic ejection systems and the patent writer and/or his company is not liable for implementation of this technology. For example, if the pilot blacks out and is automatically ejected, the pilot's, head, arms, etc. must be protected to avoid injury during exit. Also, existing skydiving training technology for pilots is cumbersome and expensive at over $100,000 each and it requires have the student get into a harness (June 2016 GSA pricelist). Our lightweight skydiving system can be setup in minutes with hardware costing less than $5,000, 1/20^{th} the cost of this harness system plus we provide simulations to prepare pilots for the dangers of Vertigo and/or G-LOC (FIG. 3).

Experts say the best training is real skydives where the novice begins in tandem jumps with the instructor and progresses to becoming a certified skydiver. Also, existing training systems don't train well for malfunctions such as rotating at 60 rpm such as the tragic death of Mark Urban, “BLM Final Accident Investigation” and cited G-LOC as a potential cause of death. Urban may have never practiced a simulated malfunction such as our August 2017 video based on real flight data of 45 rpm. Dangerous Spin (sit while watching)—https://youtu.be/U_Q82cvzQHA

### BRIEF DESCRIPTION OF THE DRAWINGS

FIG. 1 Key US Built Non-Combat Fighter Jet Crashes (2016-2018)

FIG. 2 is an overview Flow Chart logic of the Claims.

FIG. 3 shows training using our skydiving technology.

FIG. 4 shows how the system automatically ejects the pilot.

FIG. 5 Future Fighter Jets—a Few Pilots, Mainly Drones

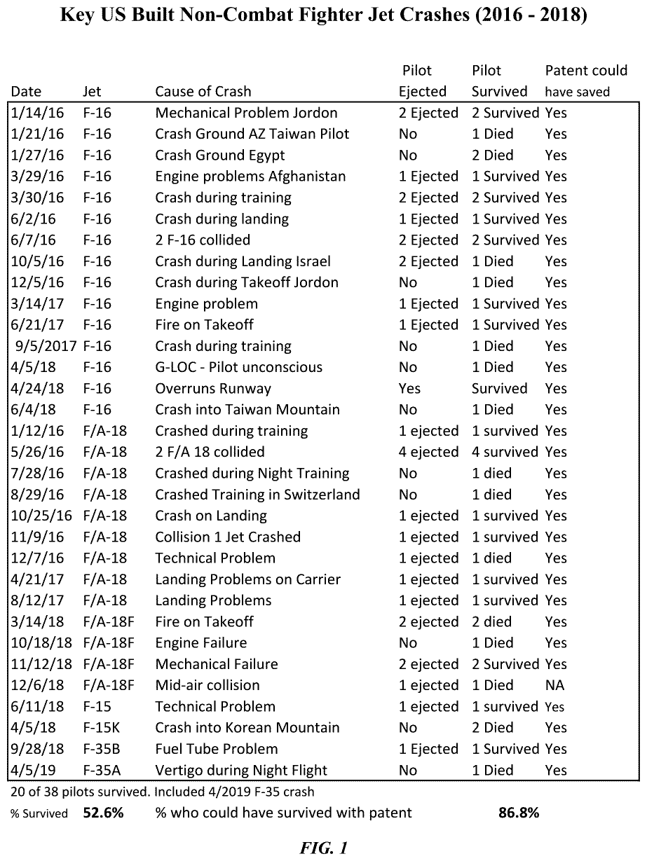

### DETAILED DESCRIPTION

This invention offers an integrated state-of-the-art pilot safety system with an amazing combination of sensors, hardware and software technologies which improves pilot safety. FIG. 2 highlights how the system: (1) automatically initiates an ejection if flight data indicates an impending crash and (2) before the flights our technology provides amazing simulations using real flight data to warn pilots of the dangers of Vertigo and G-LOC—death within seconds, plus the Skydiving Tracker—a skydiving simulator which helps train the pilot how to safely steer their parachute after an ejection towards a safe landings.

In FIG. 2 Block 1, prior to Flights, the Simulator alerts pilots to danger of Vertigo and/or G-LOC and also offers Skydiving Training. Block 2 AEST is automatically enabled when aircraft speed exceeds speed/altitude for safe ejections, i.e. 80 mph, 300 ft. Block 3 Artificial Intelligence (AI) constantly reviews the pilot's actions—if a crash is projected and there is no time to abort, then it tells the pilot—“EJECT, EJECT” to prepare the pilot and then automatically ejects the pilot. Block 4 and Block 5—if the pilot is automatically ejected, the pilot's chute is automatically deployed and the pilot (now a skydiver) with training hopefully lands safely. Block 6 —flight data, networked or black box, including real-time videos of the pilots provides a database tracking pilot performance, the need for automatic ejections and key accident/debriefing information. It immediately indicates if the pilot is impaired when flying a $100 million jet. The YouTube video below shows the flight path of a low-speed aircraft prior to a jump and how it helps train skydiving to land safely either in a normal skydive or after an ejection. Stunning YouTube Skydive Simulation into Grand Canyon—http://youtu.be/n2srxXJIQs8

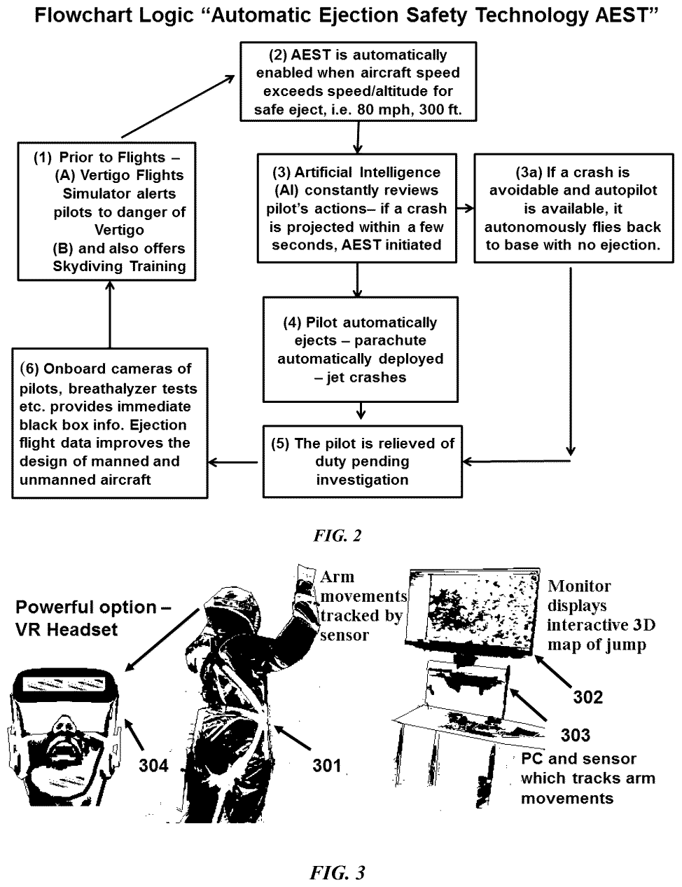

FIG. 3 shows 301 training on our non-Virtual Reality version, but a more powerful option shows a VR Headset 304 where no display 302 is needed. The sensor 303 tracks the users' arm movements like a real skydive. The jumper pulls imaginary (or real) toggles which control the chute. If their arms are straight up, they fly at the maximum speed straight ahead but if one arm, i.e. the left, is down they turn left. This technology trains both Ram and round jumpers. The U.S. Forest Service “U.S. Forest Service Ram-Air Parachute System Implementation Project” (June 2015) decided “a “square” ram-air parachute system will eventually replace the “round” FS-14 parachute system currently in use . . . . Most jumpers thought that the ram-air is more likely to lead to career ending injuries and fatalities.” while this simulator which they could use at work or home could ease their concerns. Using data from only a few jumps, trackers' flight data can simulate the types of parachutes and payloads used. A simulator which can't be customized based on real flight data performance is just a game.

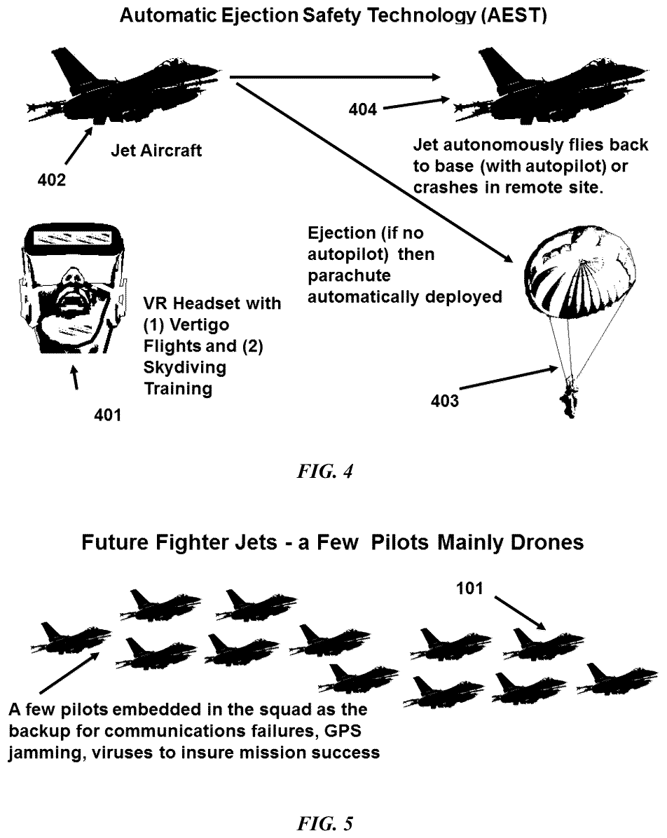

FIG. 4 shows that prior to a flight 401 the pilot trains with a Virtual Reality (VR) Headset which includes: (1) Vertigo/G-LOC Flights and (2) Skydiving Training for both round and RAM parachutes (most ejection systems use round chutes). When the onboard aircraft computers 402 senses an impending crash then the automatic ejection system is activated. However, if there is autopilot available, there is no ejection and the jet flies autonomously back to base. Crucial Skydiving Database—Over 400 skydives were tracked with the Skydiving Tracker and are part of a growing Jump History. With only 3 clicks all flight data for the aircraft/jumpers is available with interactive 3D maps/videos for debriefings/accident investigations and it's available immediately. Mark Urban's BLM accident report was issued 8 months after his death. Also, they used a flawed data logger (which they invested thousands of dollars in) which “did not render the data useless, but [increased] the degree of uncertainty associated with each data point . . . . No information was provided [regarding] the aircraft flight speed”.

The Automatic Ejection Safety Technology (AEST) with a Skydiving Simulator for Improving Pilot Safety revolutionizes pilot training and safety with: (1) Virtual Reality Skydiving Simulators which permit practicing at any real locations worldwide before flights and plus simulations to make pilots aware of the dangers of Vertigo and G-LOC and (2) an automatic system which is prepared for any crash within seconds by initiating an automatic pilot ejection is there is no other option or trying to autonomously fly the aircraft back to base. The flight data with cameras monitoring pilots provides stunning 3D interactive maps for post-jump debriefings/accident investigations far beyond existing capabilities. The Skydiving Tracker and Vertigo/G-LOC Flights should as a safety and training tool for all pilots who use ejection seats.

What is claimed is:

1. A system improving pilot safety in jet fighters' emergencies including skydiving training for pilots before flights since they may have to eject and skydive and debriefing after emergency ejections from aircraft, the system comprising:
a skydiving simulator before flights with a computer with a basic option of only keystroke controls, or with a state-of-the-art virtual reality headset with sensors which track arm movements similar to a real skydiver where the movement of a user's arms up and down controls turns and the speed of the parachute; and
a tracker where GPS and other data from the jump is automatically error-corrected, where the corrected data enhances a database of skydives and this continuously improves the simulator, which also creates 3D interactive maps for debriefings.

2. The system of claim 1 wherein this data creates a virtual reality skydiving simulator which is continuously improved by a tracker database plus feedback from expert skydivers.

3. The system of claim 1 wherein the transformation of this data into interactive maps or videos which can be used for debriefing after ejections for accident investigations.

4. The system of claim 1 further comprising: virtual reality headsets for immersion into a 3D world which is portable with just a PC and tracking sensors of arm movements (which is how the jumper controls their turns and speed) and the user explores by simply turning your head for a unique trainer system which simulates round and ram-air chutes anywhere in the world and can inexpensively.

5. A system for monitoring potential crashes instantaneously so that either an autonomous autopilot takes control if possible, if not then the Automatic Ejection Safety Technology (AEST) automatically initiates the pilot ejection.

6. The system of claim 5 further comprising: networked flight GPS data to track both the autonomously flying aircraft or the crashed aircraft and the ejected pilot.

7. The system of claim 5 further comprising: compiling a database of automatic ejection data which constantly reviews the pilot's performance including cameras which constantly monitors pilots during flights where the pilot is relieved of duty pending investigation of the automatic ejection incidents where each automatic ejection continues to improve the performance of the AEST which also could be used to improve the design and performance of both manned and unmanned aircraft with the goal of challenging both in simulated and real flights to design the ultimate jets—manned or unmanned.

8. A system for transitioning to full autonomous fleets of jet fighters with a few real pilots embedded in these fleets to insure successfully missions if these drones are infected with viruses, communication and/or GPS networks are disabled with space attacks on satellite networks where there are also robotic dummy pilots to avoid enemy drones and/or pilots targeting the few real pilots in the fleet of fighter jet drones with pilots having the ability to manually overriding their fleet of autonomous drone fighters if they have been compromised by viruses, etc.
